(19) United States
(12) Patent Application Publication
(10) Pub. No.: US 2006/0197421 A1
(43) Pub. Date: Sep. 7, 2006

(54) Halogen incandescent lamp

(75) Inventors: Wolfgang Andorfer, Munchen (DE); Axel Bunk, Munchen (DE); Frank Glockler, Schernfeld (DE); Christoph Krieglmeyer, Hofstetten (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 10/551,952

(22) PCT Filed: Apr. 6, 2004
(86) PCT No.: PCT/DE04/00723

§ 371 Date: Oct. 6, 2005

(51) Int. Cl. H01K 1/26

(52) U.S. Cl. 313/113

(57) ABSTRACT

The invention relates to a halogen incandescent lamp, part of whose lamp vessel (1) is provided with a light-reflecting coating (6) and is in the form of a reflector.

The invention relates to a halogen incandescent lamp according to the preamble of patent claim 1.

### I. PRIOR ART

Such a halogen incandescent lamp is disclosed, for example, in the European laid-open specification EP 1 255 279 A2. This specification describes a miniature halogen incandescent lamp, whose dimensions transverse to its longitudinal extent are a maximum of only 6 mm. This lamp is envisaged for use in a pocket torch.

The European patent specification EP 0 495 194 B1 describes a reflector lamp, comprising a reflector, which is formed by a parabolic or ellipsoidal glass cap, and a halogen incandescent lamp, which is arranged in the optical axis of the reflector.

### II. SUMMARY OF THE INVENTION

It is the object of the invention to provide a reflector lamp having as few components as possible and having the smallest possible dimensions.

This object is achieved according to the invention by the features of patent claim 1. Particularly advantageous refinements of the invention are described in the dependent patent claims.

The halogen incandescent lamp according to the invention has a transparent lamp vessel which is sealed off at one end and has at least one incandescent filament arranged in it, a section of the lamp vessel being in the form of a reflector and being provided with a light-reflecting coating. In comparison with a conventional reflector lamp, in the case of the halogen incandescent lamp according to the invention, the reflector forms part of the lamp vessel. This makes it possible to dispense with the glass cap of the conventional reflector lamp. The halogen incandescent lamp according to the invention therefore requires fewer components, is more cost-effective and has smaller dimensions than the conventional reflector lamps. It can be used in place of the conventional reflector lamp, for example, in downlights. This makes it possible to use correspondingly smaller openings in the false ceiling. Transverse to its longitudinal axis, the dimensions of the halogen incandescent lamp according to the invention are advantageously only a maximum of 30 mm.

The light-reflecting coating is advantageously in the form of a dichroic or metallic coating, preferably made of aluminum or silver, since these coatings have a high degree of reflection for all optical wavelengths. The halogen incandescent lamp according to the invention advantageously has a lamp vessel which is axially symmetrical with respect to a longitudinal axis, the at least one incandescent filament being arranged on the longitudinal axis, and the section of the lamp vessel which is in the form of a reflector being a ring-shaped section, which is connected to the sealed-off end of the lamp vessel and whose ring axis is identical to the longitudinal axis. As a result, the light generated by the axially aligned incandescent filament is predominantly directed in the axial direction, in the opposite direction to the sealed-off end of the lamp vessel. According to a particularly preferred exemplary embodiment of the invention, the section of the lamp vessel which is in the form of a reflector is parabolic, the rotational axis of the paraboloid being arranged on the longitudinal axis, and the vertex of the paraboloid facing the sealed-off end of the lamp vessel so as to achieve focused irradiated light pointing in the direction of the longitudinal axis of the lamp vessel. According to another advantageous embodiment of the invention, the lamp vessel is, apart from its sealed-off end, ellipsoidal, and the section which is in the form of a reflector essentially comprises a half-shell of the ellipsoidal lamp vessel. The half-shell of the ellipsoid which is in the form of a reflector preferably extends from the sealed-off end of the lamp vessel to the opposite end of the lamp vessel. As a result, the light is focused in directions transverse to the longitudinal axis of the lamp vessel. The incandescent filament is advantageously completely surrounded by the coated region of the lamp vessel, in order to reflect as much of the emitted light as possible in the desired direction. An incandescent filament having the smallest possible dimensions is advantageously used to bring its optical imaging properties more into line with those of a point light source. The length of the light-emitting part of the incandescent filament is therefore advantageously a maximum of 4.4 mm, and its external diameter is advantageously less than 2.3 mm.

The sealed-off end of the lamp vessel is advantageously in the form of a base in order to ensure that the dimensions are as small as possible and to keep the number of components as small as possible.

### III. DESCRIPTION OF THE PREFERRED EXEMPLARY EMBODIMENTS

The invention will be explained in more detail below with reference to a preferred exemplary embodiment. In the drawing:

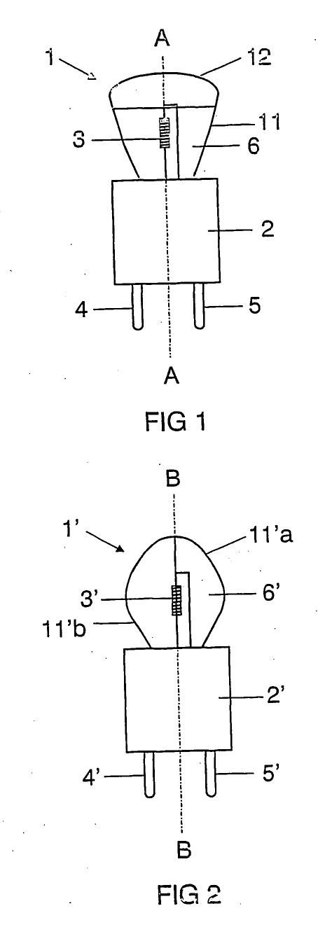

FIG. 1 shows a schematic side view of a first exemplary embodiment of the halogen incandescent lamp according to the invention, and

FIG. 2 shows a schematic side view of a second exemplary embodiment of the halogen incandescent lamp according to the invention.

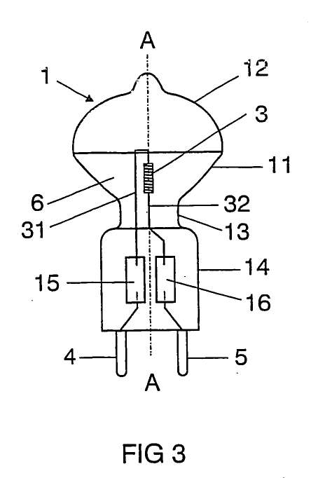

FIG. 3 shows a more detailed illustration of the first exemplary embodiment of the invention schematically illustrated in FIG. 1, including the lamp vessel seal.

The first exemplary embodiment of the invention is a low-volt halogen incandescent lamp which is operated on a voltage of 12 volts and has an electrical power consumption of approximately 50 watts. This lamp has a glassy lamp vessel 1 which is sealed off at one end. The sealed-off end 2 of the lamp vessel 1 is in the form of a GY6.35 base. The lamp vessel 1 is axially symmetrical with respect to its longitudinal axis A-A. An axially aligned incandescent filament 3, whose ends are electrically conductively connected to in each case one of the contact pins 4, 5 protruding from the base, is arranged within the lamp vessel 1. The incandescent filament 3 has an external diameter of 2.27 mm, and its light-emitting coil has a length of 4.19 mm. The section 11 of the lamp vessel 1 which is directly connected to the sealed-off end 2 in the form of a base essentially has the form of a paraboloid of rotation, whose rotational axis is identical to the longitudinal axis A-A of the lamp vessel 1. The parabolic section 11 of the lamp vessel 1 is provided on its outer surface with a non-transparent silver layer 6 which has a high optical reflection factor. The end 12 of the lamp vessel 1 which is remote from the base 2 is in the form of a flattened dome and closes the light outlet opening of the parabolic section 11 of the lamp vessel 1. The flattened dome 12 is transparent and is not provided with any coating. The light-emitting part of the incandescent filament 3 is completely surrounded by the parabolic section 11 of the lamp vessel 1 such that it is completely covered by the coating 6 in the representation in FIG. 1. The incandescent filament 3 has nevertheless been depicted in the schematic representation in FIG. 1, although it would normally not be visible in the side view in FIG. 1.

FIG. 3 shows the lamp according to the first exemplary embodiment of the invention without the base 22. In this figure, the shape of the lamp vessel 1 is illustrated more faithful to detail than in FIG. 1 and, in particular, the lamp vessel seal is also illustrated.

The parabolic section 11 provided with the light reflecting coating 6 of the lamp vessel 1 is connected to the sealed-off end of the lamp vessel 1 in the form of a pinch foot 14 via a constricted neck region 13. The pinch foot 14 is arranged in the base 2 (FIG. 1) after the lamp has been provided with the base. The neck region 13 has an inner diameter of 4 mm and an outer diameter of 6 mm. It has thus smaller transverse dimensions than the parabolic section 11 of the lamp vessel 1. Two current supply wires 31, 32 for the incandescent filament 3 extend in the neck region 13 and are in each case connected in electrically conductive manner to one of the contact pins 4, 5 via a molybdenum foil 15, 16 embedded in the pinch foot. Details of the incandescent filament 3 and its current supply wires 3, 32 are described in the laid-open specification DE 44 20 607. The light reflecting coating 6 extends also over the neck region 13 in order to prevent a light emission in this region. The non-transparent coating 6 comprises a silver layer that is arranged immediately on the outer surface of the lamp vessel.

The second exemplary embodiment of the invention is a low-volt halogen incandescent lamp which is operated on a voltage of 12 volts and has an electrical power consumption of approximately 35 watts. This lamp has a glassy lamp vessel 1′ which is sealed off at one end. The sealed-off end 2′ of the lamp vessel 1′ is in the form of a GY6.35 base. The lamp vessel 1′ is axially symmetrical with respect to its longitudinal axis B-B. An axially aligned incandescent filament 3′, whose ends are electrically conductively connected to in each case one of the contact pins 4′, 5′ protruding from the base, is arranged within the lamp vessel 1′. The incandescent filament 3′ has an external diameter of 2.17 mm, and its light-emitting coil has a length of 3.95 mm. The section of the lamp vessel 1′ which is directly connected to the sealed-off end 2′ in the form of a base essentially has the form of an ellipsoid of rotation, whose rotational axis is identical to the longitudinal axis B-B of the lamp vessel 1′. The semimajor-axis of the ellipsoid is likewise on the longitudinal axis B-B of the lamp vessel 1′. A first half-shell 11′a of the ellipsoidal section of the lamp vessel 1′ is provided on its outer surface with a non-transparent silver layer 6′ which has a high optical reflection factor. The other half-shell 11′b of the ellipsoidal section of the lamp vessel 1′ is transparent and is not provided with any coating. The longitudinal axis B-B of the lamp vessel 1′ extends within the plane of separation between the two half-shells 11′a, 11′b. However, the relationship between the coated and the uncoated parts of the surface of the ellipsoidal region of the lamp vessel 1′ may also be set to any other value between 40% and 60%.

The maximum dimensions of the lamp transverse to the longitudinal axis are 16 mm in both exemplary embodiments.

The invention is not limited to the exemplary embodiments described in more detail above. For example, the halogen incandescent lamps according to the invention may also have another base, for example a G4 base. Metals other than silver which have a similarly high reflection factor, for example aluminum, are also suitale as reflecting coating. In place of a metallic coating, light-reflecting dichroic layers may also be used.

The shape of the coated lamp vessel section 11 or 11′a must not necessarily be parabolic or ellipsoidal. Instead, the coated lamp vessel section 11 or 11′a may also have the shape of a free-form contour such as is described, for instance, in the patent specification EP 0 282 100 B1 or in the laid-open specification DE 38 08 086. Overmore, the coated lamp vessel section 11 or 11′a may also have the shape of a number of paraboloid or ellipsoid segments put together that are arranged rotation-symmetrically with the longitudinal axis A-A of the lamp vessel 1.

1. A halogen incandescent lamp having a transparent lamp vessel (1; 1′) which is sealed off at one end, and at least one incandescent filament (3; 3′) arranged within the lamp vessel (1; 1′),
characterized in that a section (11; 11′a) of the lamp vessel (1; 1′) is in the form of a reflector and is provided with a light-reflecting coating (6; 6′).

2. The halogen incandescent lamp as claimed in claim 1, characterized in that the light-reflecting coating is a metallic coating (6; 6′) on the outer surface of the lamp vessel (1; 1′).

3. The halogen incandescent lamp as claimed in claim 1, characterized in that the light-reflecting coating is a dichroic coating on the outer surface of the lamp vessel.

4. The halogen incandescent lamp as claimed in claim 1, characterized in that the lamp vessel (1) is axially symmetrical with respect to a longitudinal axis (A-A) of the lamp vessel (1), and the at least one incandescent filament (3) is arranged on the longitudinal axis (A-A) of the lamp vessel (1), the section of the lamp vessel (1) which is in the form of a reflector being a ring-shaped section (11), which is connected to the sealed-off end (2) of the lamp vessel (1) and whose ring axis is arranged on the longitudinal axis (A-A).

5. The halogen incandescent lamp as claimed in claim 1, characterized in that the section (11) of the lamp vessel (1) which is in the form of a reflector is parabolic, the rotational axis of the paraboloid being arranged on the longitudinal axis (A-A), and the vertex of the paraboloid facing the sealed-off end (2) of the lamp vessel (1).

6. The halogen incandescent lamp as claimed in claim 1, characterized in that the lamp vessel (1′) is, apart from its sealed-off end (2′), in the form of an ellipsoid, whose semimajor axis is arranged on the longitudinal axis (B-B) of the lamp vessel (1′), and a region of the lamp vessel (1′) which essentially corresponds to a half-shell (11′a) of the ellipsoid is provided with the light-reflecting coating (6′).

7. The halogen incandescent lamp as claimed in claim 6, characterized in that the half-shell (11′a) of the ellipsoid extends from the sealed-off end (2′) of the lamp vessel (1′) to the opposite end of the lamp vessel.

8. The halogen incandescent lamp as claimed in claim 4, characterized in that the dimension of the lamp vessel (1; 1′) transverse to the longitudinal axis (A-A; B-B) has a maximum value of 30 mm.

9. The halogen incandescent lamp as claimed in claim 1, characterized in that the sealed-off end (2; 2′) of the lamp vessel (1; 1′) is in the form of a base.

10. The halogen incandescent lamp as claimed in claim 1, characterized in that the incandescent filament (3; 3′) is completely surrounded by the section (11; 11′) of the lamp vessel (1; 1′) which is in the form of a reflector.

11. The halogen incandescent lamp as claimed in claim 1, characterized in that the halogen incandescent lamp is a low-volt halogen incandescent lamp, the length of the light-emitting coil of the incandescent filament (3; 3′) being less than or equal to 4.4 mm, and its external diameter being less than 2.3 mm.

12. The halogen incandescent lamp as claimed in claim 4, characterized in that the section (11) of the lamp vessel (1) which is in the form of a reflector is parabolic, the rotational axis of the paraboloid being arranged on the longitudinal axis (A-A), and the vertex of the paraboloid facing the sealed-off end (2) of the lamp vessel (1).

13. The halogen incandescent lamp as claimed in claim 4, characterized in that the lamp vessel (1′) is, apart from its sealed-off end (2′), in the form of an ellipsoid, whose semimajor axis is arranged on the longitudinal axis (B-B) of the lamp vessel (1′), and a region of the lamp vessel (1′) which essentially corresponds to a half-shell (11′a) of the ellipsoid is provided with the light-reflecting coating (6′).

14. The halogen incandescent lamp as claimed in claim 4, characterized in that the halogen incandescent lamp is a low-volt halogen incandescent lamp, the length of the light-emitting coil of the incandescent filament (3; 3′) being less than or equal to 4.4 mm, and its external diameter being less than 2.3 mm.
